(19) United States
(12) Patent Application Publication
(10) Pub. No.: US 2008/0203953 A1
(43) Pub. Date: Aug. 28, 2008

(54) CONTROL BANDWIDTH FOR COST EFFECTIVE AC MOTOR DRIVES IN AEROSPACE APPLICATIONS USING TWO DSP DEVICES WITH DISSIMILAR REDUNDANT INTER-PROCESSOR COMMUNICATION LINK

(76) Inventors: HONG ZHANG, Mississauga (CA); Zheng Wang, Mississauga (CA); You Zhou, Mississauga (CA)

Correspondence Address: HONEYWELL INTERNATIONAL INC., 101 COLUMBIA ROAD, P O BOX 2245, MORRISTOWN, NJ, 07962-2245, US

(21) Appl. No.: 11/960,282

(22) Filed: Dec. 19, 2007

Related U.S. Application Data
(60) Provisional application No. 60/892,149, filed on Feb. 28, 2007.

(51) Int. Cl. H02P 27/08

(52) U.S. Cl. 318/461

(57) ABSTRACT

A digital control system for an electric motor uses two motor-control DSP's operated in parallel to provide high bandwidth motor control. Each of the two DSP's individually may have a limited processing rate (e.g. about 150 million instructions per second [MIPS]). Parallel operation of the DSP's with efficient cross-communication may facilitate motor control at a high sampling frequency. The high sampling frequency may require processing at a rate greater than the limited processing rate (e.g. greater than 150 MIPS), but the combined DSP's may provide the requisite processing speed.

### CROSS-REFERENCE TO RELATED APPLICATIONS

This application claims the benefit of U.S. Provisional Application No. 60/892,149 filed Feb. 28, 2007.

### BACKGROUND OF THE INVENTION

The present invention is in the field of control of electrical motors and, more particularly, digital control of AC electric motors.

In many prior-art applications of AC motors, operational control is performed with digital systems. Digital motor-control systems facilitate use of control techniques such as, among other things, sensorless speed control and torque control. Typically, digital motor control may require repetitive calculations based on various algorithms. Digital signal processors (DSP's) are often employed to perform requisite calculations and to issue control commands. Indeed there is a type of commonly available DSP's which are uniquely adapted to perform motor control. Use of commonly available motor-control DSP's is desirable because such DSP's are inexpensive and are readily adaptable to perform many different control functions.

Prior-art motor-control DSP's are suitable for many industrial and vehicular motor control applications. In most prior-art applications a motor-control DSP may be required to perform calculations and issue commands at a processing rate, such as 150 million instructions per second (MIPS). Such a DSP may be considered to have a bandwidth of 150 megahertz (MHz). A 150 MHz bandwidth is sufficiently high for many prior-art motor control applications. Consequently, 150 MHz motor-control DSP's have become widely available and may be manufactured and sold at a relatively low cost.

However some aerospace motor control functions may not be readily performed with 150 MHz motor-control DSP's. Some motors in aerospace applications may have rotational speeds of 70,000 rpm or greater. In aerospace vehicles, factors such as weight, volume, electromagnetic interference (EMI) and reliability may produce a need for a motor-controller bandwidth greater than 150 MHz. Newly evolving aircraft designs are developing with a “more electrical aircraft” concept (MEA). High power inverters, such as electrical start/generator systems and variable speed motor drives for all types of loads are major MEA components.

Within this MEA environment, stringent EMI requirements have been introduced. Because long output cables (sometimes more than 100 feet between an inverter and a load) may be employed in MEA designs, inductance-capacitance (L-C) filtering may be required at an inverter output to meet EMI specifications. An L-C filter may cause serial resonance among filter elements and motor stator impedance. To achieve stable, reliable, and robust operation, a motor controller may be required to have the capability of suppressing this potential resonance. This requirement to suppress resonance may dictate that the controller possess a bandwidth that is high, relative to a frequency of the resonance. A well accepted rule is that controller bandwidth should be at least 5 times greater than a resonant frequency in order to suppress it.

In many prior-art digital control systems sampling may be performed at a beginning of every switching period of a PWM inverter. A typical inverter may operate at about 20 kilohertz (KHz). Thus prior-art sampling may be performed at intervals of about 50 microseconds (μsec). This sampling rate may not be sufficiently high to meet requirements in aerospace vehicles.

In aerospace applications, because of weight and volume considerations, the filter components, L and C, may be made deliberately small and light. But, smaller filter components produce resonance at higher frequencies. Thus, weight and volume considerations deem it desirable to push a cut-off frequency of the L-C filter as high as possible. On the other hand, the controller sampling rate may be limited by processing speed of the motor controller.

The fastest motor-control specific DSP now available in the market has the clock rate of about 150 MHz. With performance up to 150 MHz, it may provide enough control bandwidth for most industrial motor drives and digital power controllers. However, for AC motor drives in the aerospace environment where the weight, volume, reliability and cost are considered to be critical design factors, the bandwidth of 150 MHz produces a design limitation. Other families of DSP's or other high-end processors may offer higher speed either directly or through parallel processing. But these other processors are not designed for motor control. If one of these higher speed processors were used for motor control, additional hardware, such as field programmable gate arrays (FPGA) or application specific integrated circuits (ASIC), analog-to-digital converter, pulse width modulation (PWM) control etc., may be required to perform some critical motor control functions. These components may be expensive and their combined reliabilities may also be a concern in an aerospace vehicle application. These reliability and cost issues might be reduced if 150 MHz motor-control DSP's could be adapted to perform motor control functions in aerospace vehicles with controller bandwidth greater than 150 MHz.

As can be seen, there is a need to provide a high-bandwidth (e.g., greater than 150 MHz) motor control system which may be operated with conventional motor-control DSP's (e.g. DSP's having a 150 MHz bandwidth). Additionally, there is a need to provide such a system which may perform sampling at a rate greater than once per PWM switching period.

### SUMMARY OF THE INVENTION

In one aspect of the present invention an apparatus for motor control comprises a first digital signal processor (DSP) to provide speed control, a second DSP to provide current control, a controllable power source for a motor. The first and second DSP are interconnected for synchronized sampling of motor data and for repetitive synchronized provision of current control and speed control calculations to produce repetitive control commands to the power source.

In another aspect of the present invention a method of performing AC motor control with parallel processing comprises the steps of performing a first set of speed control calculations in a first processor in a first cycle of operation, performing a first set of current control calculations in a second processor in the first cycle of operation, performing a second set of current control calculations in the second processor in a second cycle of operation. The second set of calculations is based, in part, on results of the first set of speed control calculations.

In still another aspect of the present invention a method for controlling a motor comprises the steps of sampling a first set of motor data with a first processor, sampling a second set of motor data with a second processor in synchronization with the sampling of the first set of motor data, performing a first set of control calculations based on the first set of motor data with the first processor, performing a second set of control calculations based on the second set of motor data in the second processors, transferring results of the first set of calculations to the second processor and producing a motor control command with the second processor, said motor control command being based on the first and the second set of calculations.

These and other features, aspects and advantages of the present invention will become better understood with reference to the following drawings, description and claims.

### BRIEF DESCRIPTION OF THE DRAWINGS

FIG. 1 is a block diagram of a motor control system in accordance with the invention;

FIG. 2 is a block diagram of communication links in accordance with the invention;

FIG. 3 is a timing chart of processor operation in accordance with the invention;

FIG. 4 is a timing chart of inter-related processor operation in accordance with the invention;

FIG. 5 is a block diagram of software partitioning in accordance with the invention; and

FIG. 6 is a flow chart of a method in accordance with the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention may be useful in controlling motor operation. More particularly, the present invention may provide digital motor control with a bandwidth greater than about 150 MHz. The present invention may be particularly useful in aircraft and aerospace vehicles which may require high bandwidth motor control.

In contrast to prior-art high-bandwidth motor control systems, which may employ analog controls, or digital systems with field programmable gate arrays (FPGA's) or application specific integrated circuits (ASIC's), the present invention may, among other things, provide motor control through coordinated operation of two or more motor-control DSP's. The present invention, instead of performing all control calculations in a single circuit, may partition calculation tasks so that a single one of the DSP's may perform some but not all of the tasks. Additionally, the present invention may provide an efficient system of communication between the multiple DSP's which may utilize a minimal number of data exchanges between the DSP's.

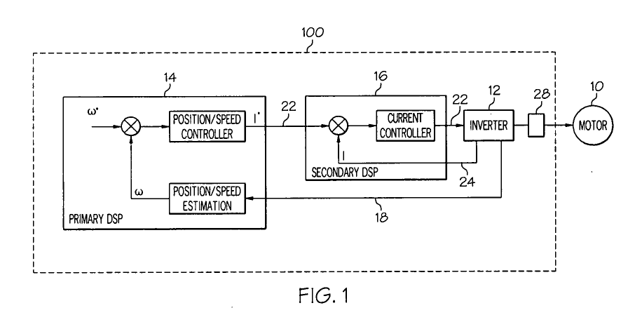

Referring now to FIG. 1, a motor-control system is designated generally by the numeral 100. As an exemplary embodiment of the invention, the motor-control system 100 may be described performing as a controller for a AC motor 10. The motor-control system 100 may perform control of other types of motors within the scope of the present invention.

The control system 100 may comprises an inverter 12, a primary DSP 14 and a secondary DSP 16. The inverter 12 may function as a controllable power source for the motor 10. The primary DSP 14 may be provided with analog motor data through a sensor circuit 18. The primary DSP 14 may perform speed/position estimation and produce current commands.

The secondary DSP 16 may receive the current commands from the primary DSP 14 through communication links 22. The secondary DSP 16 may be provided with data relating to inverter currents through a sensor circuit 24. The secondary DSP 16 may perform current control and generate pulse width modulation (PWM) signals for the inverter 12.

If the control system 100 is employed in an environment of stringent EMI requirements, an L-C filter 28 may be interposed between the inverter 12 and the motor 10. The L-C filter 28 may produce a condition in which serial resonance may develop relative to a stator (not shown) of the motor 10. The control system 100 may suppress the serial resonance. In order to provide suppression, the control system 100 may be required to operate at a frequency in excess of a frequency of the resonance.

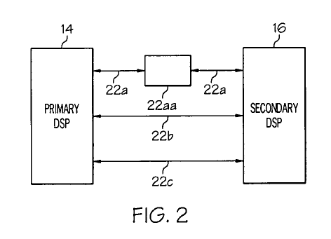

Referring now to FIG. 2, an exemplary arrangement of the communication links 22 of FIG. 1 is illustrated in detail. In the exemplary arrangement of FIG. 2, three redundant communication links 22a, 22b and 22c may interconnect the primary DSP 14 and the secondary DSP 16. The communication link 22a may comprise a direct memory access (DMA) with an external memory 22aa. The communication link 22b may comprise a serial peripheral interface (SPI) bus. The communications link 22c may comprise a general purpose in/out bus (GPIO). The communication links 22a, 22b and 22c may provide redundant and dissimilar communication links between the DSP's 14 and 16.

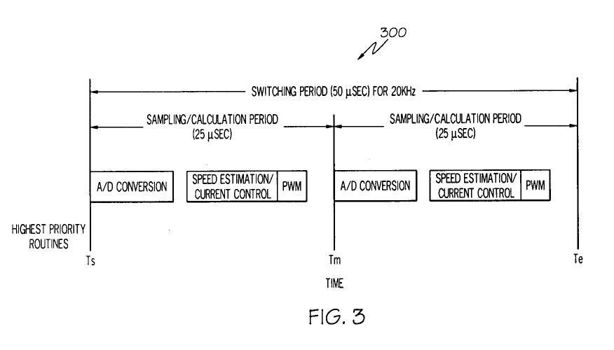

Referring now to FIG. 3 a timing chart 300 may symbolically illustrate how the control system 100 of FIG. 1 may be operated at a high sampling rate that may provide for, among other things, suppression of filter induced resonance. The chart 300 may comprise three time bars. A first time bar Ts may represent a start time of a switching period of PWM for the inverter 12 of FIG. 1. A second time bar Tm may represent a mid-point of the switching period. A third time bar Te may represent an end of the switching period. An exemplary one of the inverters 12 may operate at a frequency of 20 kilohertz (KHz). Its switching period may be about 50 μsec.

In accordance with the invention, sampling of analog motor data may be performed at the times Ts and Tm. In other words, sampling may be performed twice in the switching period, or about twice the rate of prior-art sampling. An exemplary sampling/calculation period may be about 25 μsec. An analog to digital (A/D) conversion may be performed, a speed estimation and current control function may be performed and a PWM command may be issued within the 25 μsec period.

An exemplary A/D conversion may require a processing time of about 6 μsec to about 8 μsec. An exemplary speed estimation and current control function may require processing time of about 15 μsec to about 18 μsec. An exemplary PWM command may require processing time of about 5 μsec to about 7 μsec. It may be seen that a total processing time needed to perform these functions serially at 150 MHz may exceed the 25 μsec. sampling period described above. If a single 150 MHz DSP were employed to perform these processing tasks, a sampling period of 25 μsec may not be operable because processing tasks would over run.

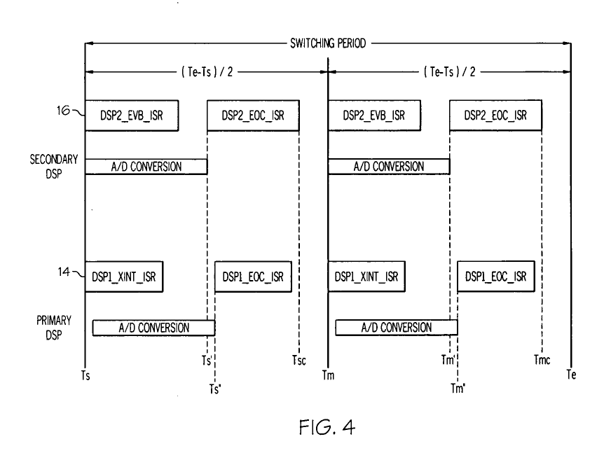

Referring now to FIG. 4, it may be seen how the DSP's 14 and 16 of FIG. 1 may be operated together to perform requisite control calculations and issue requisite commands within a sampling period that is one half of the PWM switching period.

FIG. 4 shows a partitioning system for the highest priority routines between the DSP 14 and the DSP 16. By way of example the DSP's 14 and 16 may comprise TI TMS320C2812 (TM) DSP's available from Texas Instruments, Inc. The primary DSP 14 may be a master device which may perform speed regulation, speed estimation and management. The secondary DSP 16 may be a slave device which may perform current regulations and produce PWM commands. At time Ts, the beginning of the switching period, an event-manager module B (EVB) [not shown] of the secondary DSP 16 may initiate analog-to-digital conversion. At the same time, Ts, an interrupt signal may be sent from the secondary DSP 16 to the primary DSP 14 to start analog-to-digital conversion of analog data provided to the DSP14. Thus, both DSP's 14 and 16 may start to sample their respective analog data at about the same time. Simultaneously, both DSP's 14 and 16 may execute their interrupt routines, DSP2_EVB_ISR and DSP1_XINT2_ISR, respectively, during which time digital data (e.g. data produced in a previous calculation cycle) may be exchanged. Execution times of these interrupt routines are shorter than analog-to-digital conversion times (normally 3˜4 μs to sample analog signals). The DSP's 14 and 16 may execute other lower priority routines during the remaining time.

Completion of analog-to-digital conversion may initiate a second interrupt routine. An interrupt routine, DSP1_EOC_ISR, of the primary DSP 14 may process calculations for speed regulation, speed estimation and other time critical functions. A current command for the secondary DSP 16 may be available at the end of the DSP1_EOC_ISR routine. An interrupt routine, DSP2_EOC_ISR, of the secondary DSP 16 may carry out current regulations and produce PWM commands. A PWM duty cycle may be updated at the end of the routine DSP2_EOC_ISR, thus completing a cycle of operation of the DSP's 14 and 16.

The same interrupts may be repeated in the middle of the switching period, at time Tm, thus producing a sampling/processing rate that is twice the switching rate of the inverter 12.

Execution times for exemplary motor applications may be seen in the following Table 1.

TABLE 1
Summary of Execution Time for Highest Priority Routines

| | | Execution Time | Execution Time |
|---|---|---|---|
| | | For | For |
| Interrupt | | Cabin Air | Main Engine |
| Routines Name | Major Functions | Compressor | Start |
| DSP2_EVB_ISR | Communication between two | 2.3 μs | 1.6 μs |
| (Secondary DSP 16) | DSP | | |
| | Over run check | | |
| DSP2_EOC_ISR | Hardware fault protection | 12.2 μs | 11.5 μs |
| (Secondary DSP 16) | Input data calibration and | | |
| | scaling | | |
| | Current control and PWM | | |
| DSP1_XINT2_ISR | Over run check | 0.13 μs | 0.07 μs |
| (Primary DSP 14) | | | |
| DSP1_EOC_ISR | Input data calibration and | 13.6 μs | 12.01 μs |
| (Primary DSP 14) | scaling | | |
| | Speed control and | | |
| | estimation | | |
| | Communication between | | |
| | two DSP | | |

It may be seen, in the exemplary Table 1, that execution times of each of the DSP's 14 and 16 individually may be less than 25 μsec. However, a total execution time for the DSP's 14 and 16 taken collectively may exceed 25 μsec. In other words, the processing tasks shown in Table 1 may not be completed in the exemplary time period 25 μsec if performed serially. But they may be successfully completed if performed in parallel.

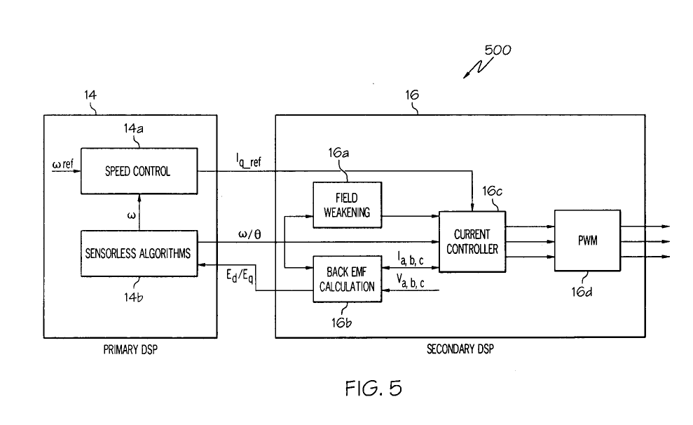

Referring now to FIG. 5, a block diagram 500 may illustrate an exemplary partitioning of core software among the primary DSP 14 and the secondary DSP 16 for parallel performance of functions that may be performed in the sampling period (e.g. 25 μsec) discussed above.

Inputs to a speed control block 14a may be speed command ω_{ref} and motor speed ω. An error of ω_{ref} and ω may be sent to a proportional & integrating (PI) regulator (not shown) to get a q-axis torque current command I_{q}_{_{—}}_{ref}.

Inputs to a sensorless algorithm block 14b may be d-axis back electromagnetic force (BEMF), E_{d} and q-axis BEMF, E_{q}. A value for −E_{d}/E_{q} may be then calculated and sent to the PI regulator to get estimated motor speed ω. Motor rotor (magnetic field) position θ may then be determined by integrating motor speed ω.

Inputs to a field weakening block 16a may be motor speed ω. When ω is lower than a rated speed, a d-axis magnetic current command I_{d}_{_{—}}_{ref}. may be set to zero. When ω is higher than the rated speed, the d-axis magnetic current command I_{d}_{_{—}}_{ref}. may be set to a negative value based on a look-up table, depending on the motor parameters.

Inputs to a BEMF block 16b may be motor voltage V_{abc}, current I_{abc}, motor speed ω and motor rotor position θ. V_{abc} & I_{abc} go through a Clark transformation and a Park transformation and then BEMF E_{dq} may be calculated based on a machine model.

Inputs of current controller block 16c may be current command I_{dq}_{_{—}}_{ref} and current feedback current I_{abc}. I_{abc} may go through the Clark and the Park transformations and the error of I_{dq}_{_{—}}_{ref} and I_{dq} may be sent to the PI regulator to get Vdq_{—ref}. V_{dq}_{_{—}}_{ref} may then go through an inverse Park and then an inverse Clark transformation to get V_{abc}_{_{—}}_{ref}. This value may be sent to PWM block 16d to get a switching pattern for an exemplary three phase one of the inverters 12 of FIG. 1.

Referring now to FIGS. 4 and 5, timing of processing activities and data exchange between the DSP's 14 and 16 may be understood. At time Ts the DSP 16 may begin A/D conversion of its analog data inputs, After the DSP 16 signals the DSP 14, the DSP 14 may begin an A/D conversion of its analog data input.

The secondary DSP 16 may begin performing its current regulation functions and production of PWM commands at time Ts′. At a later time, Ts″, the primary DSP 14 may begin performing its speed regulation, speed estimation and other time-critical calculation. Processing time for the secondary DSP 16 functions may be longer than processing time for the primary DSP 14 functions. For this reason, it may be desirable to initiate A/D conversion in the secondary DSP 16 (i.e. the longer-processing-time DSP) with an EVB signal. A/D conversion in the primary DSP 14 (i.e., the shorter-processing-time DSP) may be subsequently initiated with a signal from the DSP 16. In this way the A/D conversion activities of both of the DSP's 14 and 16 may be synchronized, but time delay arising from an inter-DSP relay effect of internal signaling may be assigned to the DSP 14 which may require a shorter processing time for its functions. This allocation of relay effects may result in a desirably close matching of processing completion times of the DSP's 14 and 16.

Completion of processing in the DSP's 14 and 16 may occur at or near a time Tsc. At the time Tsc, a newly produced PWM command may be available. Also various products of calculations, in digital data format, may be ready for transfer between the DSP's 14 and 16 so that another cycle of analog data acquisition and calculation may be performed. The digital data produced at time Tsc may be transferred at time Tm. At time Tm, more analog data may be sampled and calculation may be subsequently begun at times Tm′ and Tm″ using the transferred digital data and data produced by A/D conversion of newly acquired motor data.

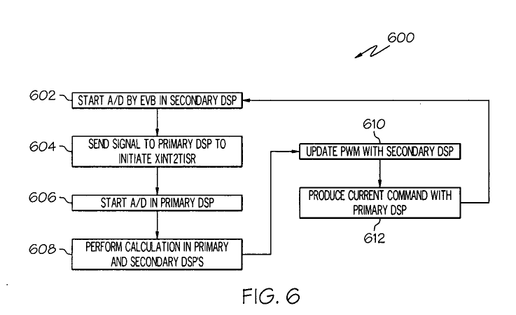

Referring now to FIG. 6, an exemplary method 600 for practicing the present invention is illustrated in a flow chart. The method 600 may be performed repetitively with the multiple processors. One cycle of the method 600 may be described in FIG. 6.

In a step 602, A/D conversion of analog data may be started in a secondary DSP (e.g., the secondary DSP 16). In a step 604 a signal may be sent to a primary DSP to initiate an interrupt (e.g., the DSP 16 may signal the DSP 14 to initiate the interrupt X_INT2_ISR). In a step 606 A/D conversion mey begin in the primary DSP. In a step 608, calculations may be performed in the primary DSP and the secondary DSP. In a step 610, a PWM update may be provided by the secondary DSP (e.g., a PWM update to the inverter 12). In a step 612, a current command may be produced and provided to the secondary DSP to begin another cycle of operation of the method 600.

The present invention is described herein with an exemplary embodiment that provides increased bandwidth of control greater than a bandwidth of a conventional motor-control DSP (e.g. 150 MHz). It must be understood, however, that designs of conventional motor-control DSP's may continue to evolve and their bandwidths may increase. Similarly, demands for increased bandwidth in motor-control may also evolve. The principles of the present invention may be applicable to any conditions in which any future motor control bandwidth demands exceed available bandwidth in future conventional motor-control DSP's.

It should be understood, of course, that the foregoing relates to exemplary embodiments of the invention and that modifications may be made without departing from the spirit and scope of the invention as set forth in the following claims.

We claim:

1. An apparatus for motor control comprising:
a first digital signal processor (DSP);
a second DSP:
a controllable power source for a motor; and
the first and second DSP being interconnected for synchronized sampling of motor data and for repetitive synchronized provision of current control and speed control calculations to produce repetitive control commands to the power source.

2. The apparatus of claim 1 wherein:
the power source is an inverter; and
the control commands are pulse width modulation (PWM) commands.

3. The apparatus of claim 2 wherein the PWM commands are produced twice during each switching period of the inverter.

4. The apparatus of claim 1 further comprising:
an inductance-capacitance (L-C) filter on an output side of the power source;
the L-C filter having a resonant frequency;
the control commands for the power source are produced at a rate higher than the resonant frequency.

5. A method of performing AC motor control with parallel processing comprising the steps of:
performing a first set of speed control calculations in a first processor in a first cycle of operation;
performing a first set of current control calculations in a second processor in the first cycle of operation;
performing a second set of current control calculations in the second processor in a second cycle of operation; and
wherein the second set of calculations includes at least a portion of the results of the first set of speed control calculations.

6. The method of claim 5 further comprising the step of acquiring motor speed data with the first processor.

7. The method of claim 5 further comprising the step of acquiring analog motor current and voltage data with the second processor.

8. The method of claim 7 further comprising the step of performing A/D conversion of the analog data in the second processor responsively to an external signal.

9. The method of claim 5 further comprising the step of performing A/D conversion of the motor speed data in the first processor responsively to a signal produced by the second processor.

10. The method of claim 5 wherein the step of performing the second set of current control calculations is based:
on motor speed data acquired by the first processor in the first cycle of operation; and
on motor current and voltage data acquired by the second processor in the second cycle of operation.

11. The method of claim 5 further comprising the steps of:
repetitively producing a PWM command to an inverter at a rate that is twice a rate of switching of the inverter.

12. A method for controlling a motor comprising the steps of:
sampling a first set of motor data with a first processor;
sampling a second set of motor data with a second processor in synchronization with the sampling of the first set of motor data;
performing a first set of control calculations based on the first set of motor data with the first processor;
performing a second set of control calculations based on the second set of motor data in the second processors;
transferring results of the first set of calculations to the second processor; and
producing a motor control command with the second processor, said motor control command being based on the first and the second set of calculations.

13. The method of claim 12 further comprising the step of providing the motor control commands to an inverter as PWM commands.

14. The method of claim 13 further comprising the step of:
filtering an output of the inverter at a resonant frequency;
wherein the step of providing PWM commands is performed repetitively at a rate at least as high as the resonant frequency.

15. The method of claim 13 wherein:
the steps of sampling are performed repetitively at a frequency that is at least twice a switching frequency of the inverter; and
the PWM commands are produced at least twice during each switching period of the inverter.

16. The method of claim 12 wherein:
the step of producing the motor control commands is performed repetitively at a frequency at least as high as 40 kilohertz (KHz); and
the steps of sampling and calculation are performed at processing speeds that do not exceed 150 million instructions per second (MIPS).

17. The method of claim 12 wherein:
the first set of motor data comprises motor speed data; and
the second set of motor data comprises data relating to current.

18. The method of claim 12 further comprising the steps of:
performing a first A/D conversion on the first set of motor data in the first processor; and
performing a second A/D conversion on the second set of motor data in the second processor.

19. The method of claim 18 wherein the step of performing the first A/D conversion is initiated responsively to a signal produced in the second processor.

20. The method of claim 19 wherein the step of performing the first set of calculations comprises performing speed control calculations.
